(19) United States
(12) Patent Application Publication
(10) Pub. No.: US 2026/0146897 A1
(43) Pub. Date: May 28, 2026

(54) SENSOR ELEMENT FOR ASCERTAINING AT LEAST ONE PHYSICAL OR CHEMICAL MEASUREMENT VARIABLE, AND SENSOR ARRANGEMENT

(71) Applicant: Innovative Sensor Technology IST AG, Ebnat-Kappel (CH)

(72) Inventors: Yannick Barb, Ebnat-Kappel (CH); Rolf Roth, Jona (CH); Rainer Schädler, Triesenberg (LI); Julia Schläpfer, Ebnat-Kappel (CH)

(21) Appl. No.: 19/104,129

(22) PCT Filed: Jul. 17, 2023
(86) PCT No.: PCT/EP2023/069787

§ 371 Date: Feb. 14, 2025

(30) Foreign Application Priority Data
Aug. 16, 2022 (DE) 10 2022 120 673.4

(51) Int. Cl. G01K 1/143; G01K 7/18

(52) U.S. Cl. CPC G01K 1/143; G01K 7/18

(57) ABSTRACT

A first variant of a sensor element for ascertaining at least one physical or chemical measurement variable, includes: a planar substrate having a first surface and a second surface opposite the first side; one or more sensor structures, which are applied to the first surface of the substrate or on an insulation layer applied to the first surface of the substrate; a passivation layer that at least partially covers the sensor structure or the sensor structures; at least two electrical contact surfaces that are each connected to the sensor structure; a spacer layer applied to one or more first portions of the second surface of the substrate; and a sinterable and/or solderable metal layer applied to one or more second portions of the second surface of the substrate and/or on the spacer layer, wherein a layer thickness of the spacer layer is greater than or equal to a layer thickness of the sinterable and/or solderable metal layer. The present disclosure also relates to a second variant of a sensor element and to a sensor arrangement which comprises at least one sensor element of this kind.

The invention relates to a first and second variant of a sensor element for ascertaining at least one physical or chemical measurement variable. Furthermore, the invention relates to a sensor arrangement which comprises one or more sensor elements according to the invention.

Sensor elements are used in a variety of applications and, depending on their design, are used, for example, to ascertain a temperature, a flow variable, a gas concentration or composition, a humidity value, a pH value and/or a biological variable, but can also be used, for example, as a heating element. For each specific application, the sensor elements often either have to be connected directly to other sensor elements or to surfaces, for example directly to the surface to be measured when using a sensor element as a surface probe. For modern-day sensor elements, which are designed in accordance with the current prior art, various processes are used, such as soldering or gluing (by using a polymer- or ceramic-based adhesive).

However, these processes used thus far have several disadvantages:

For example, during soldering, mechanical stresses can occur when the solder solidifies, which stresses are dependent on the difference in the thermal expansion coefficient of the joining partners, the difference between the joining partner and the solder, as well as the expansion differences of intermetal phases in the solder structure. These can affect the temperature coefficient of resistance (TCR), the offset of the resistance and thus the accuracy of the element. In addition, flux can poison the sensor element. In addition, temperature resistance is limited to fields of application typically below 280° C. A major disadvantage is especially evident in the hysteresis behavior of solder joints, which makes it even more difficult to reproduce small deviations in the sensor signal. Soldering processes are particularly unsuitable for applications that require high precision at the same time as a fast response time.

When using critical atmospheric environments (e.g., with moisture influences, large temperature changes and increased temperatures), it is necessary to clean the printed circuit board and soldering points of flux residues, as these might lead to failures later on in the application. This process usually requires chemicals and is an additional step that involves costs.

When using one of the above-mentioned adhesives, the phase transition or shrinkage during curing can induce stresses in the sensor element and reduce accuracy. In addition, adhesive joints cause larger contact resistances, which change over time and thus show a drift in the long-term behavior. The adhesive bond is also brittle and the degree of adhesion is limited depending on the substrate (only applies to bonding with glass and ceramic adhesives).

In addition, both during soldering and gluing, different expansion coefficients between the adhesive or solder can also induce stresses when the temperature changes and thus change the TCR of the sensor element. Adjusting the TCR is not always possible and is very complex. Furthermore, long-term stability at higher temperatures is greatly limited.

In order to reduce or even completely prevent these disadvantages mentioned above, silver sintering processes are used. Especially in printed circuit board technology, when manufacturing electrical assemblies in the high-temperature range with active and passive components (including integrated semiconductor modules), targeted temperature measurement is necessary. But even when connecting the sensor element to metal surfaces, such as stainless steel tubes with resistance elements for flow determination, a reproducible and, above all, drift-free connection is a prerequisite.

Methods are known from the prior art, for example from WO 2020/057859 A1 and DE 10 2010 050 315C5 , which allow a passive or active component (including resistance elements or sensor elements) to be silver sintered onto a carrier element. However, these components have a flat underside, meaning that the component is sintered onto the carrier over an undefined and inaccurate distance. In addition, the component may be mounted at an angle. Among other things, this has a direct effect on the thermal bonding and, above all, a very large effect on the shear strength of the connection. This results in the major disadvantage (which also exists for soldering and gluing) that the manufacturing process is not reproducible. This means that heat transfer is always different-sometimes better, sometimes worse. The same also applies to the induced voltage, which causes an offset during the joining process. However, these disadvantages are extremely important for production for a sufficient yield to be produced or for the components to be manufacturable at all.

Proceeding from the problems listed, the object of the invention is to provide a sensor element which allows for firm and thermally stable thermal contact with a carrier element.

This object is achieved by a sensor element according to claim 1, by a sensor element according to claim 2 and by a sensor arrangement according to claim 11.

With regard to a first sensor element according to the invention, said sensor element is used to ascertain at least one physical or chemical measurement variable, wherein the sensor element comprises:
a planar substrate having a first surface and a second surface that is opposite the first side;
one or more sensor structures applied to the first surface of the substrate or to an insulation layer that is applied to the first surface of the substrate;
a passivation layer that at least partially covers the sensor structure or sensor structures; at least two electrical contact surfaces each connected to the sensor structure;
a spacer layer applied to one or more first portions of the second surface of the substrate; and
a sinterable and/or solderable metal layer applied to one or more second portions of the second surface of the substrate and/or to the spacer layer, wherein the thickness of the spacer layer is greater than or equal to the thickness of the sinterable and/or solderable metal layer.

With regard to a second sensor element according to the invention, said second sensor element is used to ascertain at least one physical or chemical measurement variable, wherein the sensor element comprises:
a planar substrate having a first surface and a second surface that is opposite the first side;
one or more sensor structures applied to the first surface of the substrate or to an insulation layer that is applied to the first surface of the substrate;
a passivation layer that at least partially covers the sensor structure or sensor structures;
at least two electrical contact surfaces each connected to the sensor structure;
a sinterable and/or solderable metal layer applied to one or more second portions of the second surface of the substrate or to the entire second surface of the substrate; and
a spacer layer that is applied to one or more first portions of the second surface of the substrate and/or at least partially to the sinterable and/or solderable metal layer, wherein the thicknesses of the spacer layer and the sinterable and/or solderable metal layer are selected such that a distance between the surface of the spacer layer and the second surface of the substrate is greater than or equal to a distance between the surface of the sinterable and/or solderable metal layer and the second surface of the substrate.

The sensor elements according to the invention thus each have structures for silver sintering or soldering, which allow the stress-free, thermal, high-temperature-resistant, simple, fast and on-site connection of the substrate to a suitable surface. The spacer layer on the second surface of the substrate can define the volume of silver-sintering or solder paste in the subsequent silver sintering or soldering process. Furthermore, if designed accordingly (for example when using two or more first portions), the spacer layer can also prevent the sensor element from tilting during soldering or silver sintering.

The spacer layer has, for example, a height of 5 to 400 μm, preferably 5 to 150 μm.

The two variants of the sensor element according to the invention differ in terms of their layer structure. While in the first variant the spacer layer is applied first, followed by the sinterable and/or solderable metal layer, in the second variant this is done the other way around. Here, the sinterable and/or solderable metal layer is applied first, followed by the spacer layer. This means that, in each variant, different thicknesses must be chosen for the two layers so that a defined distance or space can be created for the solder or paste.

According to an advantageous embodiment of the sensor element according to the invention, it is provided that the sinterable and/or solderable metal layer consists of gold, platinum, copper, nickel, chromium, glass, ceramic, titanium, palladium or a combination of the aforementioned materials. Combinations of the aforementioned materials can be, for example, NiAu, NiCrNiAu, NiPdAu, CrPtAu, TiPtAu, AgPd, AgPdPt or AuPd.

According to an advantageous embodiment of the sensor element according to the invention, it is provided that the spacer layer consists of metal, polymer, glass, ceramic or a combination of the aforementioned materials.

According to an advantageous embodiment of the sensor element according to the invention, it is provided that the spacer layer which has a three-dimensional structure. This means that the individual parts of the spacer layer, which are applied according to how many first portions there are, are, in themselves, structured. This can be, for example, in the shape of a column.

According to an advantageous embodiment of the sensor element according to the invention, it is provided that one or more third portions of the second surface are provided that are free of the sinterable and/or solderable metal layer and the spacer layer.

According to an advantageous embodiment of the sensor element according to the invention, it is provided that the sensor structure or sensor structures are designed such that the sensor element can be used as a temperature sensor, as a flow sensor, as a gas sensor, as a humidity sensor, as a heating element, as a pH sensor and/or as a biosensor. Other sensor applications not listed here are also conceivable.

According to an advantageous embodiment of the sensor element according to the invention, it is provided that the one or more sensor structures consist of a metal material, in particular platinum, and are applied to the first surface of the substrate or to the insulation layer by means of a thin-film or thick-film method. For example, screen printing can be used as the thick-film method. PVD or CVD can, for example, be chosen as the thin-film method.

According to an advantageous embodiment of the sensor element according to the invention, it is provided that the spacer layer is applied by means of a thick-film method.

According to an advantageous embodiment of the sensor element according to the invention, it is provided that the sinterable and/or solderable metal layer is applied by means of a thick-film or thin-film method.

With regard to the sensor arrangement, it is provided that said sensor arrangement comprises one or more sensor elements according to the invention and a carrier element having a metal surface, wherein the sensor element or sensor elements is/are connected to the carrier element by means of silver sintering or soldering, wherein a silver-sintering or solder layer is arranged between the metal surface of the carrier element and the sinterable and/or solderable metal layer of the sensor element or sensor elements.

According to an advantageous embodiment of the sensor arrangement according to the invention, it is provided that the carrier element is a printed circuit board, wherein the metal surface is formed by a metal coating applied to the printed circuit board, wherein the metal coating consists of one or more metal materials. Instead of a printed circuit board, a carrier element made of a ceramic material can also be used, which also has a metal surface formed by such a metal coating.

According to an advantageous embodiment of the sensor arrangement according to the invention, it is provided that the carrier element is a tube or plate consisting of a metal material. In this case, the carrier element directly has one or more suitable metal surfaces.

The invention is explained in greater detail with reference to the following figures. In the FIGURE:

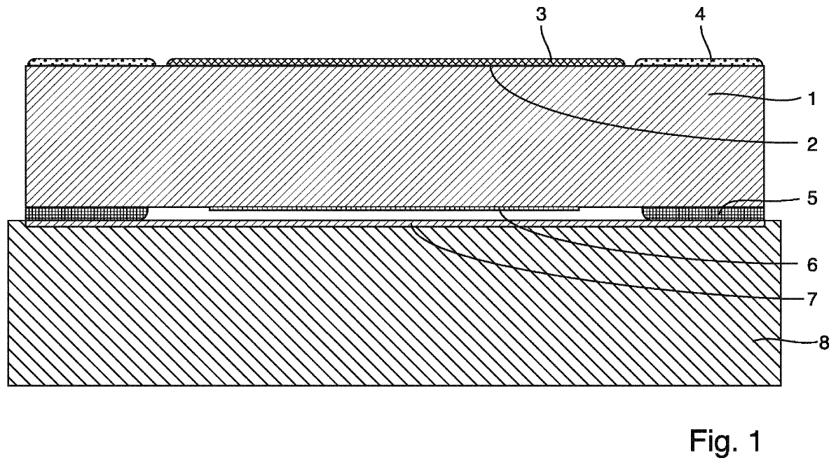

FIG. 1 is an exemplary embodiment of a sensor arrangement according to the invention, in which a sensor element is applied to a carrier element.

The sensor element consists of a planar substrate 1, which is made, for example, of a ceramic material, a metal material or a semiconductor material. A sensor structure 2 is applied to a first surface of the substrate 1. If the substrate 1 is made of a metal material, an insulation layer is applied between the first surface and the sensor structure 2 in order to electrically insulate the sensor structure 2 from the metal substrate 1. To protect against environmental influences, e.g., mechanical and/or chemical stress, the sensor structure 2 is at least partially covered by a passivation layer 3.

The sensor structure 2 is a resistance structure or an electrode structure. The sensor element can therefore be operated as a temperature sensor or as a heating element. However, depending on the number and design of the sensor structures 2, several other types of sensor element can be provided, including a temperature sensor, a flux or flow sensor, a gas sensor, a humidity sensor, a pH sensor, a biosensor, etc.

The sensor structure 2 is conductively connected to at least two electrical contact surfaces 4. The sensor structure can be actuated or electrically operated via the guide surfaces 4, e.g., by an external control and evaluation unit.

For surface mounting on any surface, e.g., each a conducting track or other carrier element 8, the sensor element has a special structure on a second surface of its substrate 1:

On the second surface of the substrate, at least a portion, or several portions, of this surface is/are covered with a sinterable and/or solderable metal layer 6. This is applied, for example, by means of a thin-film method and serves as an anchor point for the paste or solder during the subsequent silver sintering or soldering process. The sinterable and/or solderable metal layer 6 can, for example, consist of one or more materials from the group: NiAu, NiCrNiAu, NiPdAu, CrPtAu, TiPtAu, AgPd, AgPdPt, AuPd, Au or Cu.

In addition, spacer layers 5 are applied to one or more second portions of the second surface of the substrate 1, which spacer layers may be made of metal, polymer, glass, ceramic or combinations thereof and are applied by means of a thick-film or thin-film method.

Such a spacer layer 5 is thicker than the sinterable and/or solderable metal layer 6. The volume of the solder or paste can be determined by the height difference between these two layers (sinterable and/or solderable metal layer 6 and spacer layer). Furthermore, the spacer layer 5, or a plurality of these spacer layers 5, ensure(s) that the sensor element can be placed in parallel with the surface to be sintered/soldered during the soldering or silver sintering process. Selecting the material for the spacer layer 5 also makes it possible to select whether the spacer layer 5 bonds with the solder or paste or whether no additional adhesion is generated mechanically. For example, ventilation channels can be, for example, specifically structured to allow the volatile reaction components in the process to escape more easily and to enable a better quality connection. Furthermore, mechanical stress distributions can be specifically relocated, decoupled or even significantly reduced.

The sensor element can be connected to a carrier element 8, for example to metal materials but also to printed circuit boards, as shown in FIG. 1, by means of soldering or silver sintering 8. On printed circuit boards, silver sintering takes place on a metal coating in the form of a metal surface, which consists of one or more metals.

It can also be provided that the sinterable and/or solderable metal layer 6 completely or partially covers the spacer layer 5, for example by completely coating the entire back of the substrate 1, including the spacer layer 5, with a thin film.

It can also be provided that the sinterable and/or solderable metal layer 6 is applied first and then the spacer layer 5. If the spacer layer 5 covers the sinterable and/or solderable metal layer 6, the spacer layer 5 does not have to be thicker than the sinterable and/or solderable metal layer 6. However, care must be taken to ensure that a distance between the surface of the spacer layer 5 and the second surface of the substrate 1 is greater than or equal to a distance between the surface of the sinterable and/or solderable metal layer 6 and the second surface of the substrate 1 so as to create a volume for the solder or the paste.

Some advantages of the solution according to the invention are described below:
Lower drift and hysteresis behavior (compared to a soldering method);
Mechanical decoupling to avoid stresses caused by temperature gradients and different expansion coefficients between the sensor element and the carrier element 8;
Good thermal transition when using a silver paste;
Temperature resistance up to min. 400° C.;
No aggressive substances or other elements necessary that can poison the sensor;
Can be carried out at the customer's premises-process plants now exist for silver sintering applications that are also suitable for mass production.
Greater process reliability and reproducibility: It is not only possible to establish a defined distance, but also defined volumes. This also means that the heat capacity and heat transfer are defined more precisely, which can be advantageous in flow applications, for example.

### LIST OF REFERENCE SIGNS

1 Substrate
2 Sensor structure(s)
3 Passivation layer
4 Electrical contact surfaces
5 Spacer layer
6 Sinterable and/or solderable metal layer
7 Metal surface
8 Carrier element

1-13. (canceled)

14. A sensor element for ascertaining at least one physical or chemical measurement variable, the sensor element comprising:
a planar substrate including a first surface and a second surface opposite the first surface;
one or more sensor structures applied to the first surface of the substrate or to an insulation layer applied to the first surface of the substrate;
a passivation layer at least partially covering the one or more sensor structures;
at least two electrical contact surfaces that are each connected to the one or more sensor structures;
a spacer layer applied to one or more first portions of the second surface of the substrate; and
a sinterable and/or solderable metal layer applied to one or more second portions of the second surface of the substrate and/or to the spacer layer, wherein a thickness of the spacer layer is greater than or equal to a thickness of the sinterable and/or solderable metal layer.

15. A sensor element for ascertaining at least one physical or chemical measurement variable, the sensor element comprising:
a planar substrate including a first surface and a second surface that is opposite the first surface;
one or more sensor structures applied to the first surface of the substrate or to an insulation layer applied to the first surface of the substrate;
a passivation layer at least partially covering the one or more sensor structures;
at least two electrical contact surfaces that are each connected to the one or more sensor structures;
a sinterable and/or solderable metal layer applied to one or more second portions of the second surface of the substrate or to the entire second surface of the substrate; and
a spacer layer applied to one or more first portions of the second surface of the substrate and/or at least partially to the sinterable and/or solderable metal layer, wherein thicknesses of the spacer layer and the sinterable and/or solderable metal layer are selected such that a distance between a surface of the spacer layer and the second surface of the substrate is greater than or equal to a distance between a surface of the sinterable and/or solderable metal layer and the second surface of the substrate.

16. The sensor element according to claim 14,
wherein the sinterable and/or solderable metal layer consists essentially of gold, platinum, copper, nickel, chromium, glass, ceramic, titanium, palladium or a combination of the aforementioned materials.

17. The sensor element according to claim 14,
wherein the spacer layer consists essentially of metal, polymer, glass, ceramic or a combination of the aforementioned materials.

18. The sensor element according to claim 14,
wherein the spacer layer includes a three-dimensional structure.

19. The sensor element according to claim 14,
wherein one or more third portions of the second surface are provided, which are free of the sinterable and/or solderable metal layer and the spacer layer.

20. The sensor element according to claim 14,
wherein the one or more sensor structures is/are configured such that the sensor element can be used as a temperature sensor, as a flow sensor, as a gas sensor, as a humidity sensor, as a heating element, as a pH sensor and/or as a biosensor.

21. The sensor element according to claim 14,
wherein the one or more sensor structures consist essentially of a metal material and are applied to the first surface of the substrate or to the insulation layer by a thin-film or thick-film method.

22. The sensor element according to claim 14,
wherein the spacer layer is applied by a thick-film method.

23. The sensor element according to claim 14,
wherein the sinterable and/or solderable metal layer is applied by a thick-film or thin-film method.

24. A sensor arrangement, comprising one or more sensor elements according to claim 14 and a carrier element with a metal surface,
wherein the sensor element or the sensor elements is/are connected to the carrier element by silver sintering or soldering, wherein a silver-sintering or solder layer is arranged between the metal surface of the carrier element and the sinterable and/or solderable metal layer of the sensor element or sensor elements.

25. The sensor arrangement according to claim 24,
wherein the carrier element is a printed circuit board, wherein the metal surface is formed by a metal coating applied to the printed circuit board, wherein the metal coating consists of one or more metal materials.

26. The sensor arrangement according to claim 24,
wherein the carrier element is a tube or plate consisting of a metal material.

27. The sensor arrangement according to claim 14, wherein the spacer layer includes a three-dimensional structure in a form of a column.

28. The sensor arrangement according to claim 21, wherein the one or more sensor structures consist essentially of platinum.
